(19) United States
(12) Patent Application Publication
(10) Pub. No.: US 2010/0261146 A1
(43) Pub. Date: Oct. 14, 2010

(54) APPARATUS AND METHOD FOR MOTION CORRECTING AND MANAGEMENT SYSTEM FOR MOTION CORRECTING APPARATUS

(76) Inventor: DONG KYUN KIM, Gunpo-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/726,898

(22) Filed: Mar. 18, 2010

(30) Foreign Application Priority Data
Apr. 10, 2009 (KR) 10-2009-0031214

(51) Int. Cl. A63B 69/36; G09G 5/08; G09B 19/00

(52) U.S. Cl. 434/252; 345/158; 434/258

(57) ABSTRACT

Disclosed are a motion correction apparatus, a method of controlling the same, and a motion correction service system using the same. A motion correction apparatus includes a motion detector that detects user motion; a memory that stores reference motion data; a correction guide section that outputs correction guide data; and a controller that compares the user motion detected by the motion detector with the reference motion data stored in the memory to create the correction guide data used to correct the user motion, and controls the correction guide section to output the correction guide data.

### CROSS-REFERENCE TO RELATED APPLICATION

This application claims the benefit under 35 U.S.C. §119 of Korean Patent Application No. 10-2009-0031214, filed Apr. 10, 2009, which is hereby incorporated by reference in its entirety.

### BACKGROUND

The embodiment relates to a motion correction apparatus, a method of controlling the same, and a motion correction service system using the same.

As a motion recognition technology has been developed, a motion correction method has been developed to measure and analyze the motion of a user and teach a corrected motion to the user. According to the related art, a transmitter, which transmits a sensing signal based on the motion of the user, and a host device, which processes or analyzes the sensing signal, are required to correct the motion of the user.

The transmitter is attached to the body of the user making a specific motion to sense the motion of the user and transmits the sensing signal to the host device.

The host device receives and processes the sensing signal from the transmitter to recognize the motion of the user. The host device includes a display or audio equipment to deliver the recognition result for the motion of the user.

Accordingly, the motion correction method according to the related art requires a host device to detect the motion of the user and deliver the information of the corrected motion.

### BRIEF SUMMARY

According to an embodiment, a motion correction apparatus includes a motion detector that detects user motion; a memory that stores reference motion data; a correction guide section that outputs correction guide data; and a controller that compares the user motion detected by the motion detector with the reference motion data stored in the memory to create the correction guide data used to correct the user motion, and controls the correction guide section to output the correction guide data.

According to an embodiment, a method of controlling the motion correction apparatus includes storing reference motion data; detecting user motion; comparing data about the user motion with the reference motion data to create correction guide data used to correct the user motion; and outputting the correction guide data.

According to an embodiment, a motion correction service system includes a server that provides reference motion data for motion correction through a network; a computer that converts the reference motion data provided from the server according to a preset body size of the user; and a motion correction apparatus that receives and stores the converted reference motion data from the computer, detects user motion, compares data about the user motion with the reference motion data, and outputs correction guide data used to correct the user motion according to a comparison result.

### BRIEF DESCRIPTION OF THE DRAWINGS

FIG. 1 is a perspective view showing a motion correction apparatus according to an embodiment;

FIG. 2 is a control block diagram showing the motion correction apparatus according to an embodiment;

FIG. 3 is a view showing the use of the motion correction apparatus according to an embodiment;

FIG. 4 is a control block diagram showing a motion correction service system employing the motion correction apparatus according to an embodiment; and

FIG. 5 is a flowchart showing the control of the motion correction apparatus according to an embodiment.

### DETAILED DESCRIPTION

Hereinafter, a motion correction apparatus, a method of controlling the same, and a motion correction service system using the same will be described with reference to accompanying drawings.

In the description of embodiments, it will be understood that when a layer (or film) is referred to as being ‘on’ another layer or substrate, it can be directly on another layer or substrate, or intervening layers may also be present. Further, it will be understood that when a layer is referred to as being ‘under’ another layer, it can be directly under another layer, and one or more intervening layers may also be present. In addition, it will also be understood that when a layer is referred to as being ‘between’ two layers, it can be the only layer between the two layers, or one or more intervening layers may also be present.

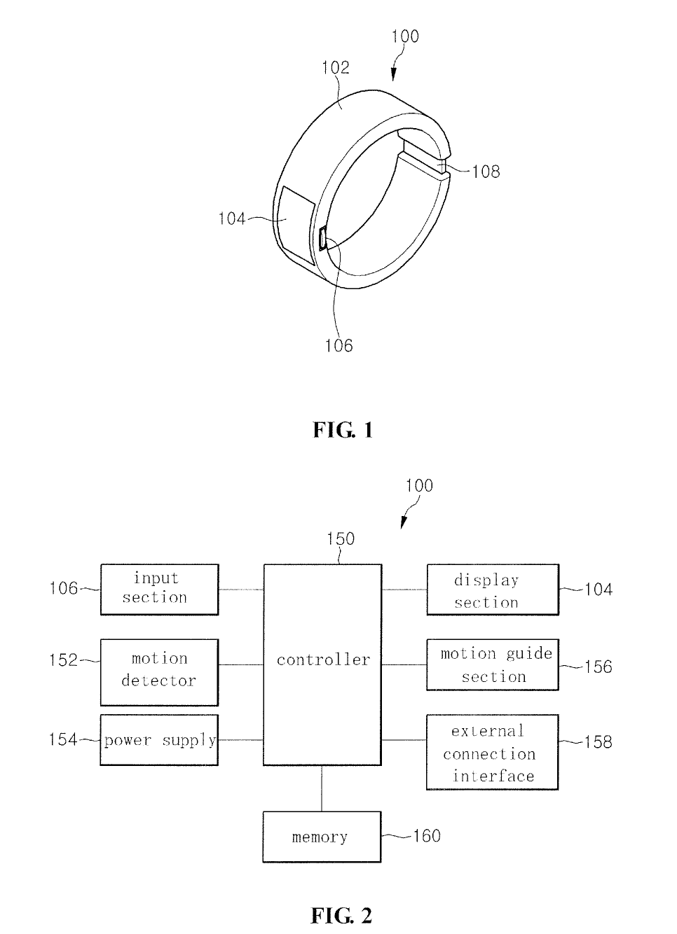

FIG. 1 is a view showing an outer appearance of a motion correction apparatus 100 according to an embodiment.

As shown in FIG. 1, the motion correction apparatus 100 according to an embodiment includes a band section 102, which has a curved shape attachable to the body of a user; a display section 104, which is attached to a portion of an outer side surface of the band section 102; and an input section 106 for user's manipulation.

The band section 102 is manufactured suitably for the curvature of a body to closely make contact with the body. The band section 102 is provided therein with components (not shown) to provide guide information of a corrected motion to the user in cooperation with the motion of the user. The band section 102 may have a ring shape such that the band section 102 can be easily worn on the wrist, ankle, or neck of the user. The band section 102 includes a flexible material such as silicon to protect embedded circuits while closely making contact with the body.

A fastening section 108 may be formed at a predetermined section of the band section 102. The fastening section 108 fastens or releases the band section 102. The fastening section 108 may include a fastening part, a buckle, or a hook. In addition, the fastening section 108 includes an elastic section having elasticity greater than that of the band section 102.

The display section 104 can display various data such as stored data, a motion mode, a motion amount, and motion time.

The input section 106 receives information of an on/off operation and display data from the user. The input section 106 may be realized in the form of a jog dial, a touch panel, or a button.

The motion correction apparatus 100 having the above structure may have a band shape wearable on the arm or the leg of the user. The motion correction apparatus 100 can be realized in various forms, such as a belt or a headband, according to attachment sections to the body of the user.

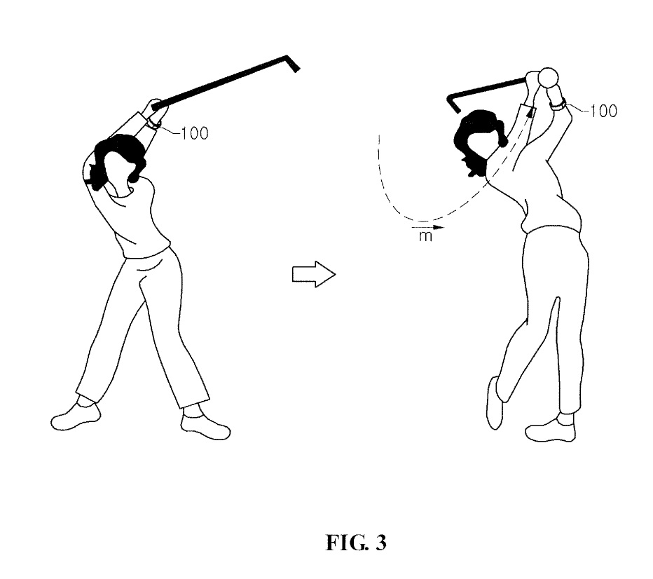

FIG. 2 is a control block diagram of the motion correction apparatus 100 according to an embodiment.

The motion correction apparatus 100 according to an embodiment includes the input section 106, the display section 104, a power supply 154, an external connection interface 158, a motion detector 152, a memory 160 to store motion data of the user, and a controller 150, which compares data of user motion detected by the motion detector 152 with user motion data stored in the memory 160 to create motion guide data and output the motion guide data to a motion guide section 156.

The motion detector 152 detects at least one of a motion direction, a motion angle, and a motion speed based on the motion of the user to provide the detected value to the controller 150. The motion detector 152 may include a gyro sensor to detect a rotational angular velocity of a moving object and an acceleration sensor to detect the acceleration of a moving object. For example, a micro-gyro using a micro electro-mechanical system (MEMS) based on a semiconductor manufacturing technology can minimize the size of the device to a few millimeters or less and can accurately detect 3-axis motion information.

The memory 160 stores user motion data serving as a criterion to correct user motion. The user motion data may be stored in the memory 160 when the motion correction apparatus 100 is manufactured, or may be received from the outside and stored in the memory 160. In addition, the memory 160 may store user motion data detected by the motion detector 152.

The motion guide section 156 outputs motion guide data used to correct the user motion. The motion guide data can be provided in the various forms such as vibration, sound effects, images, and voice. When the motion is guided in the form of vibration, the motion guide section 156 may include a vibration motor. When the motion guide section 156 includes an audio circuit, the motion guide section 156 may guide user motion through sound effects or voice. If the display section 104 serves as the motion guide section 156, the display section 104 may guide user motion in the visible form such as an image or text.

The controller 150 compares motion data detected by the motion detector 152 with user motion data stored in the memory 160. The controller 150 creates motion guide data, which is used to correct user motion, according to the comparison result. The controller 150 outputs the motion guide data to the motion guide section 156. If the motion data detected by the motion detector 152 is different from the user motion data stored in the memory 160, the controller 150 drives the vibration motor of the motion guide section 156 or rings an alarm sound.

The controller 150 can calculate the motion amount and the motion time of a user based on the motion data detected by the motion detector 152. The controller 150 can create statistic data such as a motion correction rate according to movement time of the user.

The external connection interface 158 can be connected with an external device such as a computer or a host device. The external connection interface 158 includes both wire interfaces such as USB and IEEE1394 and wireless interfaces such as Bluetooth, ZigBee, and IrDA. In this case, the controller 150 can cooperate with an external device through the external connection interface 158. The controller 150 can store user motion data, which have been provided from the external device connected with the external connection interface 158, in the memory 160 or output the motion detection data stored in the memory 160 to the external device.

The input section 106 provides an input selected by a user to the controller 150. The input section 106 may include a jog dial, a button, or a touch panel. The input section 106 receives on/off setting information, operation mode setting information, or a display command from the user and delivers the user input to the controller 150.

The display section 104 can display data under the control of the controller 150. The display section 104 can display user motion data, motion time, or motion correction rate that is currently set.

The power supply 154 supplies power to drive the motion correction apparatus 100. The power supply 154 includes a battery. For example, the power supply 154 may employ a small rechargeable USB battery.

The control structure can be realized in a flexible highly-integrated device in which small chips are mounted on a flexible printed circuit board (FPCB). Accordingly, the control structure can be embedded in the curved band section 102.

As described above, the motion correction apparatus 100 has the structure to detect user motion and correct the user motion in one unit. Accordingly, the motion correction apparatus 100 can be easily carried by a user. In addition, the motion correction apparatus 100 can be actually used in places such as a swimming pool or a playground, so that a learning effect can be improved, and user interest can be increased through motion correction.

Meanwhile, when the motion detector 152 detects the movement of a user based on a global positioning system (GPS), the controller 150 compares the moving route of the user with a reference route so that a user route can be guided through the motion guide section 156.

In order to guide the moving route, the memory 160 stores a desirable moving route and reference motion data.

The motion detector 152 can detect user motion, that is, the moving route of the user based on a GPS.

The controller 150 compares the moving route of the user detected by the motion detector 152 with the moving route stored in the memory 160 to determine if the user deviates from a desirable moving route. The controller 150 can output the determination result through the motion guide section 156.

For example, a user may climb a mountain after wearing the motion correction apparatus 100 having information of mountain trails as reference motion data. If the moving route of the user detected by the motion detector 152 is different from the information of the mountain trails stored in the memory 160, the motion correction apparatus 100 can inform the user that the user deviates from the mountain trails through the motion guide section 156.

FIG. 3 is a view showing the use of the motion correction apparatus 100 according to one embodiment, and, particularly, showing the use of the motion correction apparatus 100 according to an embodiment for the purpose of correcting a golf swing motion.

When a golf swing motion is guided, user motion data stored in the memory 160 may include information of an arm's movement necessary for a proper golf swing.

A user may wear the motion correction apparatus 100 on the wrist in order to correct a golf swing motion. The motion detector 152 of the motion correction apparatus 100 detects the movement of a user's wrist to provide the information about the movement of the user's wrist to the controller 150.

Upon receiving the information from the motion detector 152, the controller 150 can detect the moving route m of the user's arm. The controller 150 compares the measured information about the movement of the user's arm with the information about the arm's movement for a desirable golf swing.

If the measured information about the movement of the user's arm is different from the information about the arm's movement for the desirable golf swing, the controller 150 drives a vibration motor of the motion guide section 156 to inform the user that the user motion is not correct. In addition, the controller 150 can output a voice message or ring an alarm sound. In another embodiment, even if a user motion is correct, the controller 150 controls the motion guide section 156 to output a sound effect of notifying the user that the user motion is correct.

Although one motion correction apparatus 100 is employed in the above description, a user can additionally wear motion correction apparatuses 100 on both wrists, both ankles, and an ankle and/or a wrist. If a plurality of motion correction apparatuses 100 is used, the motion of each body section can be more exactly corrected.

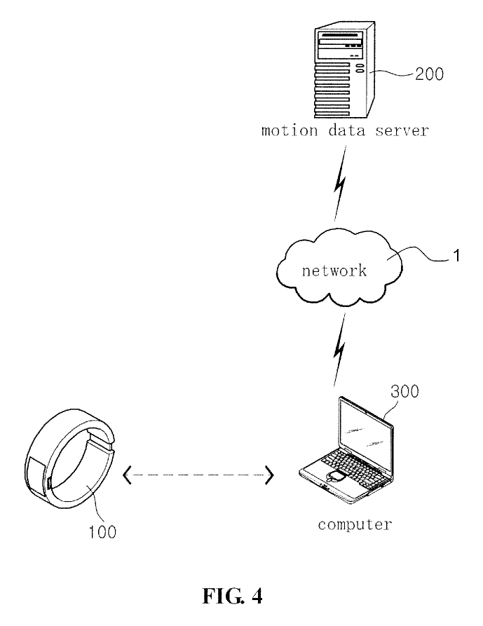

FIG. 4 is a control block diagram showing a motion correction service system employing the motion correction apparatus according to an embodiment.

As shown in FIG. 4, the motion correction service system includes a motion data server 200, which provides reference data used to correct user motion through a network 1, and a computer 300, which receives the reference data from the motion data server 200 to provide the motion data to the motion correction apparatus 100, and receives and manages the data of the motion correction apparatus 100.

The motion data server 200 provides motion data for motion correction in various sports or dances. The motion data server 200 can provide a web page including a list of sport or dance names such that a user can select motion data.

After the user accesses the motion data server 200 by using a device (e.g., desktop computer or notebook computer), which is accessible to the network 1, the user can select and download motion data.

The motion correction apparatus 100 can make data communication with the computer 300 through the external connection interface 158.

The computer 300 can provide motion data, which have been downloaded from the motion data server 200, to the motion correction apparatus 100. The computer 300 can request detected data stored in the motion correction apparatus 100. A user interface program can be installed in the computer 300 such that the computer 300 communicates with the motion correction apparatus 100. Accordingly, the user may store motion data, which has been downloaded to the computer 300, in the motion correction apparatus 100, and may move the data of the motion correction apparatus 100 into the computer 300.

The computer 300 processes the detected data provided by the motion correction apparatus 100 to represent a motion correction history or a motion correction rate.

If the motion data server 200 provides motion data for users having a standard body size, the computer 300 can convert the motion data into motion data suitable for a user based on user information of a height and a weight input by the user. The conversion of motion data may be performed by the motion data server 200. In other words, the motion data server 200 may manage motion data according to users to provide motion data corresponding to the body size of a user. In this case, user motion data suitable for the user are directly provided to the motion correction apparatus 100 without an additional conversion process on the computer 300.

Through the structure, a management system of the motion correction apparatus 100 according to an embodiment can check data stored in the motion correction apparatus 100 or download motion data from the motion data server 200 to store the motion data in the motion correction apparatus 100 through the computer 300. Accordingly, after motion data acquired by the user has been stored in the motion correction apparatus 100, the user can exercise and correct the motion in a desired place.

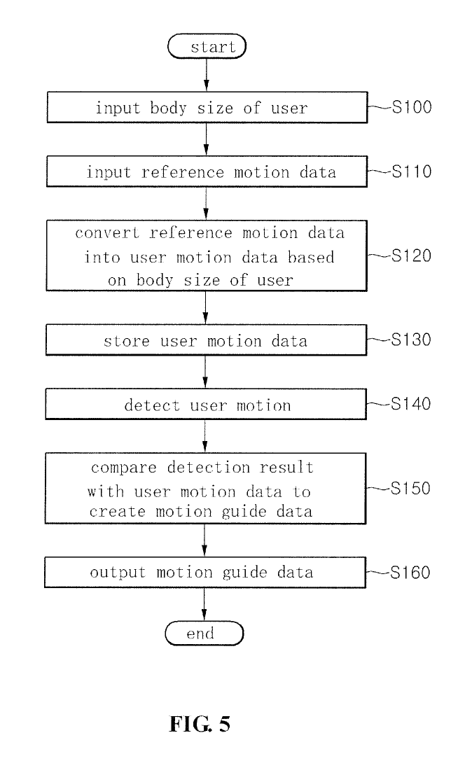

FIG. 5 is a flowchart showing a service method for motion correction according to an embodiment.

A body size such as a height or a weight of a user who wants to use the motion correction apparatus 100 is input (step S100), and reference motion data for motion correction are input (step S110).

The reference motion data are converted into user motion data according to the body size of the user (step S120). Steps S110 and S120 can be performed in the computer 300 that is accessible to the motion correction apparatus 100 and the motion data server 200. In addition, the motion data server 200 can directly provide the user motion data.

The user motion data are stored in the motion correction apparatus 100 (step S130). The user connects the motion correction apparatus 100 to the computer 300 to store necessary motion data in the motion correction apparatus 100.

The motion correction apparatus 100 detects user motion through the motion detector 152 (step S140). The controller 150 of the motion correction apparatus 100 compares the detected user motion data with the stored user motion data to create motion guide data (step S150).

The controller 150 of the motion correction apparatus 100 outputs the motion guide data (step S160). The motion guide data can be provided in the various forms such as vibration, sound effects, images, or voice to indicate motion correction.

Embodiments provide a motion correction apparatus, which can be simply carried by a user and can provide a motion correction function to the user regardless of locations or environments, thereby improving the learning effect and increasing the interest of the user; a method of controlling the motion correction apparatus; and a motion correction service system using the same.

What is claimed is:

1. A motion correction apparatus comprising:
a motion detector that detects user motion;
a memory that stores reference motion data;
a correction guide section that outputs correction guide data; and
a controller that compares the user motion detected by the motion detector with the reference motion data stored in the memory to create the correction guide data used to correct the user motion, and controls the correction guide section to output the correction guide data.

2. The motion correction apparatus of claim 1, wherein the motion detector includes at least one of a gyro sensor, an acceleration sensor, and a global positioning system (GPS) device.

3. The motion correction apparatus of claim 1, wherein the correction guide section includes at least one of a vibration motor, an audio section, and a display section.

4. The motion correction apparatus of claim 1, further comprising an external connection interface for connection with an external device,
wherein the controller receives the reference motion data through the external connection interface and stores the reference motion data in the memory, and provides information stored in the memory to the external device through the external connection interface.

5. The motion correction apparatus of claim 4, wherein the external connection interface includes at least one of a wire interface and a wireless interface.

6. The motion correction apparatus of claim 1, further comprising:
a user input section that delivers an input selected by a user to the controller; and
a display section that displays information under a control operation of the controller.

7. The motion correction apparatus of claim 1, further comprising a band section having a ring shape attachable to a body of the user such that the user motion is transmitted to the motion detector.

8. A motion correction service system comprising:
a server that provides reference motion data for motion correction through a network;
a computer that converts the reference motion data provided from the server according to a preset body size of the user; and
a motion correction apparatus that receives and stores the converted reference motion data from the computer, detects user motion, compares data about the user motion with the reference motion data, and outputs correction guide data used to correct the user motion according to a comparison result.

9. The motion correction service system of claim 8, wherein the server provides a web page displaying a list of sport or dance names corresponding to the reference motion data.

10. The motion correction service system of claim 8, wherein the computer receives and stores detection data according to user motion from the motion correction apparatus and statistically processes the detection data.

11. The motion correction service system of claim 8, wherein the computer includes a user interface program enabling the computer to make data communication with the motion correction apparatus.

12. A method of controlling a motion correction apparatus, the method comprising:
storing reference motion data;
detecting user motion;
comparing data about the user motion with the reference motion data to create correction guide data; and
outputting the correction guide data.

13. The method of claim 12, wherein the storing of the reference motion data includes:
receiving the reference motion data through one of a wireless interface and a wire interface, and
storing the reference motion data in a memory.

14. The method of claim 13, wherein the receiving and storing of the reference motion data includes:
receiving reference motion data corresponding to a body size of the user from a computer connected with the one of the wireless interface and the wire interface, and
storing the reference motion data in the memory.

15. The method of claim 12, wherein the detecting of the user motion includes detecting a moving route of the user, and
wherein the outputting of the correction guide data includes outputting the correction guide data if the user deviates from a reference moving route.

16. The method of claim 12, wherein the outputting of the correction guide data includes outputting the correction guide data in a form of one of vibration, sound effects, voice, and images.
